(19) United States
(12) Patent Application Publication
(10) Pub. No.: US 2008/0247377 A1
(43) Pub. Date: Oct. 9, 2008

(54) INDEPENDENT MEDIUM ACCESS CONTROL FOR DISCOVERING WIRELESS NETWORKS

(76) Inventors: Peter Van Horn, San Jose, CA (US); David Friedman, Atherton, CA (US)

Correspondence Address: EDOUARD GARCIA;Attorney At Law, 1351 Cuernavaca Circulo, Mountain View, CA, 94040, US

(21) Appl. No.: 11/697,362

(22) Filed: Apr. 6, 2007

(51) Int. Cl. H04B 7/212

(52) U.S. Cl. 370/348

(57) ABSTRACT

In one aspect, a wireless transceiver transmits and receives wireless signals, and medium access controller independently initiates transitions from a scanning state to a power conserving state and from the power conserving state to the scanning state. In the scanning state, the medium access controller directs the wireless transceiver to receive frames on at least one wireless channel and the medium access controller scans the received frames for identifiers of one or more respective target access points. In the power conserving state, the medium access controller places at least one of the wireless transceiver and the medium access controller in a low-power mode of operation.

### BACKGROUND

Network discovery refers to the process that is used by a wireless station to discover nearby networks that are available for connection. The discovery process typically involves scanning specific wireless channels for wireless signals that are transmitted by access points (or base stations) that act as hubs for communications between the wireless station and wired networks (e.g., a local area network). The scanning process may be passive or active. In a passive network discovery scan, the wireless station listens for beacons that are transmitted by nearby access points. In an active network discovery scan, the wireless station transmits probe requests and listens for both beacons and probe responses. After a target access point has been discovered, a wireless station may attempt to connect through that access point to its associated wired network.

Power consumption reduction strategies have been developed to meet the needs of battery-powered wireless devices. For example, many wireless communications protocols define mechanisms that enable various power reduction implementations. The IEEE 802.11 standard, for example, defines a power save polling mode of operation that allows a wireless station to transition to a sleep state when there is no expected network traffic. In accordance with this mode of operation, the wireless station receives beacon frames from an access point. Each beacon frame includes a parameter field that indicates whether or not there are any buffered frames in the access point that are intended for the station. If the beacon parameter indicates that there are no such buffered frames, the wireless station can enter the sleep state until the next sleep interval expires. A sleep interval usually is several Beacon intervals. After each beacon frame that indicates there is data to download, the wireless station transmits a power save polling frame to request the data, and the access point responds with an acknowledgement frame followed by a respective set of frames containing the requested data. After receiving the last frame of each frame set, the wireless station transitions from the receiving state back into the sleep state.

The power save polling mode of operation, as well as its various extensions and improvements, provide effective means for reducing power consumption after a wireless station has joined a network. These methods, however, do not apply during the network discovery phase of interfacing with the network. What are needed are apparatus and methods that support power reduction strategies during wireless network discovery.

### SUMMARY

In one aspect, the invention features an apparatus that includes a wireless transceiver and a medium access controller. The wireless transceiver is operable to transmit and receive wireless signals. The medium access controller is operable to independently initiate transitions from a scanning state to a power conserving state and from the power conserving state to the scanning state. In the scanning state, the medium access controller directs the wireless transceiver to receive frames on at least one wireless channel and the medium access controller scans the received frames for identifiers of one or more respective target access points. In the power conserving state, the medium access controller places at least one of the wireless transceiver and the medium access controller in a low-power mode of operation.

The invention additionally features a medium access control method in accordance with which at least one transceiver control signal is output in a scanning state. The transceiver control signal specifies at least one wireless channel. Received frames also are scanned for identifiers of one or more respective target access points in the scanning state. In a power conserving state, at least one medium access control signal dictating a low-power mode of operation is output. Transitions from the scanning state to the power conserving state and from the power conserving state to the scanning state are independently initiated.

The invention also features a machine readable medium storing machine-readable instructions causing a medium access controller to perform the medium access control method described above.

Other features and advantages of the invention will become apparent from the following description, including the drawings and the claims.

### DESCRIPTION OF DRAWINGS

FIG. 1 is a block diagram of an embodiment of a wireless local area network that includes an access point and a wireless station that has a host module and an auto-scan enabled wireless module.

FIG. 2 is a block diagram of an embodiment of the wireless station shown in FIG. 1 that includes an auto-scan enabled medium access controller.

FIG. 3 is a block diagram of an embodiment of the wireless module shown in FIG. 2.

FIG. 4 is flow diagram of an embodiment of an independent network discovery method implemented by an embodiment of the auto-scan enabled medium access controller shown in FIG. 2.

FIG. 5 is a flow diagram of an embodiment of an independent network discovery method implemented by an embodiment of the auto-scan enabled medium access controller shown in FIG. 2.

FIG. 6 is a flow diagram of an embodiment of a passive scanning method implemented in an embodiment of the method of FIG. 5.

FIG. 7 is a flow diagram of an embodiment of an active scanning method implemented in an embodiment of the method of FIG. 5.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Introduction

The embodiments that are described in detail below support power reduction strategies during wireless network discovery. In particular, these embodiments include an “auto-scan” enabled medium access controller that is operable to independently initiate transitions from a network discovery scanning state to a power conserving state and from the power conserving state to the scanning state. This contrasts with other wireless station designs in which requests from a host processing unit is required to initiate each network discovery scan by medium access controller.

By integrating independent network discovery functionality in the medium access controller, these embodiments support the implementation of various power saving strategies during the network discovery phase of interfacing with a wireless network. For example, in some embodiments, the host processing unit may reside in a low-power state while the medium access controller independently scans for available network connections. In this way, the power consumed in these embodiments may be significantly reduced in relation to wireless stations in which the host processing unit is involved in each scan operation that is performed by the medium access controller.

As used herein the term “wireless” refers to any form of non-wired signal transmission, including AM and FM radio transmissions, TV transmissions, cellular telephone transmissions, portable telephone transmissions, wireless LAN (local area network) transmissions, and wireless PAN (personal area network) transmissions. A wide variety of different methods and technologies may be used to provide wireless transmissions in the embodiments that are described herein, including infrared line of sight methods, cellular methods, microwave methods, satellite methods, packet radio methods, and spread spectrum methods (e.g., direct sequence spread spectrum methods, frequency hopping spread spectrum methods, or a combination of both direct sequence and frequency hopping spread spectrum methods).

The embodiments that are described herein may be implemented by relatively small, low-power and low-cost wireless station components. As a result, these embodiments are highly suitable for incorporation in wireless communications environments that have significant size, power, and cost constraints, including but not limited to handheld electronic devices (e.g., a mobile telephone, a cordless telephone, a portable memory device such as a smart card, a personal digital assistant (PDA), a video camera, a still image camera, a solid state digital audio player, a CD player, an MCD player, a game controller, and a pager), portable computers (e.g., laptop computers), computer peripheral devices (e.g., input devices, such as wireless computer mice and wireless computer keyboards), sensor devices (e.g., temperature sensors and other environmental monitoring devices), and other embedded environments.

### II. Overview

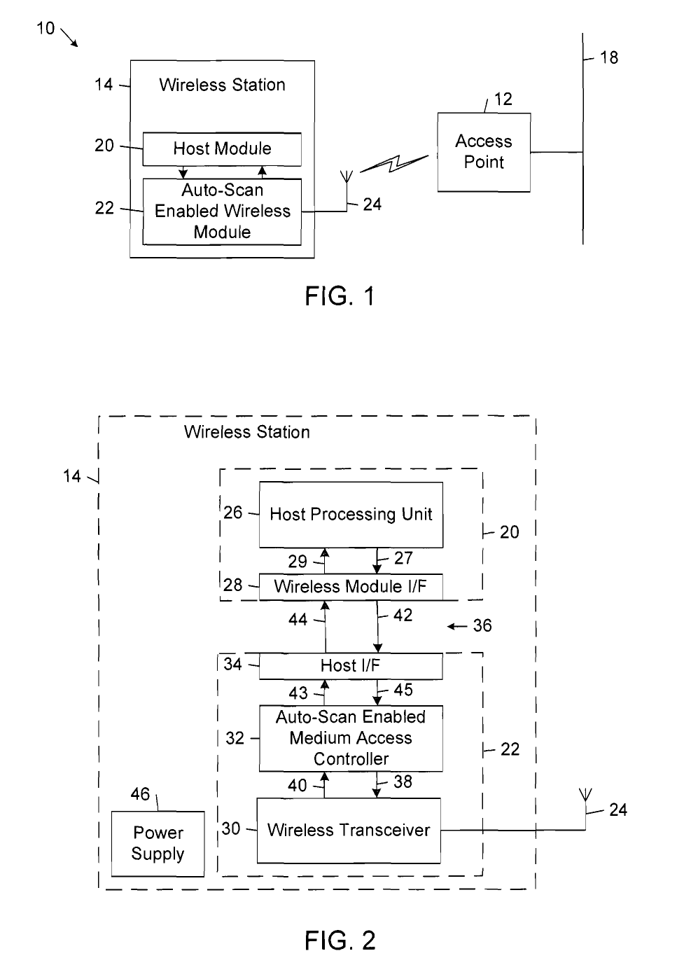

FIG. 1 shows an embodiment of a wireless local area network 10 that includes an access point 12 and a wireless station 14. The access point 12 acts as a hub for communications between the wireless station 14 and a wired network 18, which typically is a local area network. In the illustrated embodiment, the wireless station 14 includes a host module 20 and an “auto-scan” enabled wireless module 22. As used herein, the term “auto-scan” refers to a mode of operation in which transitions from a network discovery state to a power-conserving state, and vice versa, are initiated independently of any external control mechanism (e.g., signals received from the host module 20).

In general, the wireless station 14 may be implemented by any type of electronic device, including but not limited to handheld electronic devices (e.g., a mobile telephone, a cordless telephone, a portable memory device such as a smart card, a personal digital assistant (PDA), a video camera, a still image camera, a solid state digital audio player, a CD player, an MCD player, a game controller, and a pager), portable computers (e.g., laptop computers), computer peripheral devices (e.g., input devices, such as wireless computer mice and wireless computer keyboards), sensor devices (e.g., temperature sensors and other environmental monitoring devices), and other embedded environments. The wireless station 14 is capable of communicating wirelessly with the access point 12 in accordance with a wireless communication protocol. Exemplary wireless communication protocols include, but are not limited to, the IEEE 802.11 (WiFi) protocol, the IEEE 802.15.1 (Bluetooth) protocol, and the IEEE 802.15.4 (Zigbee) protocol.

In operation, the host module 20 issues various host requests to the wireless module 22. The wireless module 22 processes the host requests and performs various functions in accordance with those requests. The wireless module 22 typically is operable to perform MAC and PHY layer functions specified in one or more wireless communication protocols, such as the IEEE 802.11 (WiFi) protocol, the IEEE 802.15.1 (Bluetooth) protocol, and the IEEE 802.15.4 (Zigbee) protocol. In general, these MAC and PHY layer functions include, but are not limited to, ensuring that the wireless station 14 and the access point 12 communicate with the correct frame format and protocol.

In addition to performing standard MAC and PHY layer functions, the wireless module 22 also is operable to independently initiate transitions from a network discovery scanning state to a power conserving state and from the power conserving state to the scanning state. As explained above, this auto-scan feature of the wireless module 22 frees the host module 20 from having to be involved in each network discovery scan, allowing the host module 20 to perform other tasks or to enter a low-power state during the network discovery phase of operation. If a target access point is discovered during a scan, the wireless module 22 will transmit a report signal to the host module 20. If the host module 20 is in a low-power mode of operation when it receives the report signal, the receipt of the report signal will cause the host processing module 20 to transition from the low-power mode of operation to a wake mode of operation. Typically, the wireless module 22 will transmit the report signal in the form of an initial interrupt signal that wakes the host module 20, if necessary, followed by one or more frames that communicate the reason for the interrupt.

### III. Exemplary Embodiments of the Wireless Station

FIG. 2 shows an embodiment of the wireless station 14, which includes an embodiment of the host module 20 and an embodiment of the wireless module 22. In the illustrated embodiment, the host module 20 includes a host processing unit 26 and a wireless module interface (I/F) 28. The wireless module 22 includes a wireless transceiver 30, an auto-scan enabled medium access controller 32, and a host interface 34. The wireless station 22 also includes a power supply 46. The power supply 46 typically is a battery, a fuel cell, or other electrical power store that can be recharged (e.g., an AC power adapter that is connected to AC utility power) or otherwise reconditioned.

The host processing unit 26 typically includes one or more processors, each of which may be in the form of any one of various commercially available processors. The host processing unit 26 also may include a read only memory (ROM) that stores a basic input/output system (BIOS) that contains start-up routines for the host module 20 and a random access memory (RAM). The host processing unit transmits signals 27 to the wireless module 22 and receives signals 29 from the wireless module 22 via the wireless module interface 28. The host processing unit 26 typically executes various processes that control various aspects of the operation of the wireless station 14. In some embodiments, the host processing unit 26 transmits to the medium access controller 32 an “auto-scan” request signal that directs the medium access controller 32 to enter an independent network discovery state during which the medium access controller 32 independently transitions between the scanning state and the power conserving state without prompting by any additional signals from the host processing unit 26.

The wireless module interface 28 is electrically coupled to the host interface 34 by a bus 36. In general, the bus 36 may be implemented in accordance with any type of data link protocol, including but not limited to the serial peripheral interface (SPI) bus protocol, the queued serial peripheral interface (QSPI) bus protocol, the I²C serial computer bus protocol, and the SDIO bus protocol.

The wireless transceiver 30 typically includes an analog portion that interfaces with the antenna 24 and a digital portion that interfaces with the medium access controller 32. The analog transceiver portion typically performs up-conversion of baseband transmit (TX) data signals 38 that are received from the medium access controller 32 and outputs baseband receive (RX) data signals 40, which are down-converted versions of the signals received from the antenna 24. In some embodiments, the up- and down-conversion functions are performed using super-heterodyne techniques. In other embodiments, the up- and down-conversion functions are performed using direct conversion techniques.

The medium access controller 32 provides a process connection between the host processing unit 26 and the wireless transceiver 30. Among other functions, the medium access controller 32 partitions data signals 42, 43 that are received from the host processing unit 26 and the wireless transceiver 30 into frames, and passes output signals 44, 45 containing the frames to the wireless transceiver 30 and the host processing unit 26. In some embodiments, medium access controller 32 performs some or all of the MAC layer functions specified in one or more wireless communication protocols, such as the IEEE 802.11 (WiFi) protocol, the IEEE 802.15.1 (Bluetooth) protocol, or the IEEE 802.15.4 (Zigbee) protocol. In embodiments in which the medium access controller 32 does not perform all of the desired MAC layer functions, a driver running on the host module performs the remainder of the desired MAC protocol functions.

The medium access controller 32 typically is implemented by one or more discrete data processing components (or modules) that are not limited to any particular hardware, firmware, or software configuration. These data processing components may be implemented in any computing or data processing environment, including in digital electronic circuitry (e.g., an application-specific integrated circuit, such as a digital signal processor (DSP)) or in computer hardware, firmware, device driver, or software. In some embodiments, process instructions (e.g., machine-readable code, such as computer software) for implementing some or all the MAC protocol functions that are executed by the medium access controller 32, as well as the data it generates, are stored in one or more machine-readable media. In general, the term “machine-readable medium” refers to any medium capable carrying information that is readable by a machine. Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

Components of the host module 20 and the wireless module 22 may be implemented on one or more integrated circuit chips. In some embodiments, the host processing unit 20 is implemented on one integrated circuit chip and the medium access controller 32 and one or more components of the wireless transceiver are implemented on another integrated circuit chip. In other embodiments, the host processing unit 20, the medium access controller 32, and one or more components of the wireless transceiver are implemented on a single integrated circuit chip.

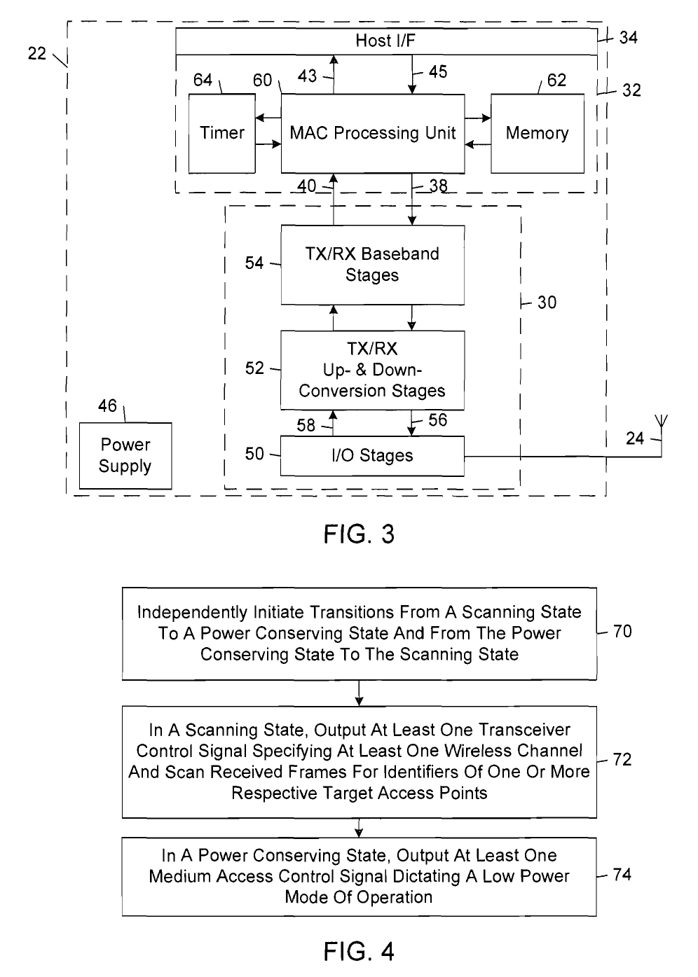

FIG. 3 shows an embodiment of the wireless module 22 that includes an embodiment of the wireless transceiver 30 and an embodiment of the medium access controller 32.

In this embodiment, the wireless transceiver 30 includes input/output (I/O) stages 50, TX/RX stages 52, and TX/RX baseband stages 54. The output stage typically includes a power amplifier for amplifying output signals 56 received from the up-conversion stage before they are passed to the antenna 24 for wireless transmission. The input stage typically includes a low noise amplifier that amplifies signals received by the antenna 24 and passes the resulting amplified signals 58 to the down-conversion stage. The TX/RX up- and down-conversion stages 52 typically include RF filters, a TX variable gain preamplifier circuit, an RX automatic gain control circuit, a local oscillator, and up- and down converters. The TX/RX baseband stages 54 typically include baseband amplifiers, filters, a TX digital-to-analog converter circuit, and an RX analog-to-digital converter circuit. The circuitry in the baseband stage 54 operates in a frequency range from 0 Hertz (Hz) up to a maximum frequency that is substantially below the frequency of the output signal 56 and the amplified input signal 58. In typical RF applications, the maximum baseband frequency typically is below 100 MHz, whereas the maximum frequency of the output/input signals 56, 58 typically is in the GHz frequency range.

The medium access controller 32 includes a MAC processing unit 60, memory 62, and a timer 64. The MAC processing unit 60 may be implemented in at least one of hardware, software, and firmware. In some embodiments, the memory 62 is implemented by one or more of the following technologies: RAM, ROM, EEPROM, Flash memory, and registers.

The memory 62 typically stores firmware instructions specifying various MAC protocol operations, default configuration data, data for calibrating the wireless transceiver 30, and a MAC address that is assigned to the wireless module 22. The memory 62 also provides storage for TX/RX data buffering.

The MAC processing unit 60 typically includes a processor (e.g., a microcontroller, a microprocessor, or an ASIC) and one or more hardware accelerators. The processor executes the machine-readable firmware instructions that are stored in the memory 62. The hardware accelerators perform time-critical MAC functions, including checksum operations, media sense functions, quality of service functions, and encryption/decryption functions. The medium access controller 32 processes the baseband RX signals 40 into frames 40, filters the frames 40, and outputs via the host interface 34 the frames 40 intended for the host processing unit 26. Many frames, such as beacon frames and association frames, fall into the category of management frames which are processed entirely within the MAC logic. The medium access controller 32 also processes the signals 45 received from the host processing unit 26, packages the data contained in the host signals 45 into frames 38 and outputs the frames to the wireless transceiver 30 for wireless transmission to the network.

The timer 62 typically is implemented in hardware and is used by the medium access controller 32 to measure sleep intervals during which the wireless module 22 operates in a low-power sleep mode between scanning states in the independent network discovery mode of operation.

### IV. Independent Medium Access Control for Discovering Wireless Networks

A. Overview

In operation, the host module 20 issues host request signals to the wireless module 22. The medium access controller 32 processes the host requests and performs various functions in accordance with those requests. The medium access controller typically is operable to perform some or all of the MAC layer functions specified in one or more wireless communication protocols, such as the IEEE 802.11 (WiFi) protocol, the IEEE 802.15.1 (Bluetooth) protocol, and the IEEE 802.15.4 (Zigbee) protocol. In some embodiments, the medium access controller 32 performs at least the following 802.11 MAC layer functions: JOIN; AUTHENTICATE; ASSOCIATE; TRANSMIT DATA; and RECEIVE DATA. Some of these embodiments additionally may perform the following 802.11 MAC layer functions: PRE-AUTHENTICATE; and RE-ASSOCIATE. In other embodiments, the medium access controller 32 may perform comparable MAC layer functions in accordance with a non-802.11 wireless communications protocol, such as the IEEE 802.15.1 (Bluetooth) protocol or the IEEE 802.15.4 (Zigbee) protocol. Any desired MAC layer functions that are not performed by the medium access controller 32 typically are performed by a driver running on the host module 20.

As explained above, in addition to performing MAC layer functions defined by one or more wireless communication protocol standards, the medium access controller 32 also is operable to enter an independent network discovery mode of operation in response to receipt of an auto-scan request signal from the host processing unit 26. In the independent network discovery mode of operation, the medium access controller 32 independently initiate transitions between a network discovery scanning state and a power conserving state.

In some embodiments, after transmitting the auto-scan request signal to the medium access controller 32, the host processing unit 26 enters a low-power state of operation during which data communications from the host processing unit 26 to the medium access controller 32 are suspended. As used herein, the term “data communications” refers to signals containing network data that is received from another network node (e.g., the access point 12 or another wireless station) or is addressed to another network node. The term “data communications” does not encompass the transmission of control signals (e.g., interrupts or wake-up trigger signals) between the host processing unit 26 and the medium access controller 32. In the low-power operational state, some or all of the components of the host module 20 are transitioned to a low-power state.

If a target access point is discovered during a scan, the medium access controller 32 will transmit a report signal to the host processing unit 26. If the host processing unit 26 is in a low-power mode of operation when it receives the report signal, the receipt of the report signal will cause the host processing unit to transition from the low-power mode of operation to a wake mode of operation. Typically, the medium access controller 32 will transmit the report signal in the form of an initial interrupt signal that wakes the host processing unit 26, if necessary, followed by one or more frames that communicate the reason for the interrupt.

### B. A First Embodiment of Independent Medium Access Control for Discovering Wireless Networks

FIG. 4 shows an exemplary embodiment of method that is implemented by embodiments of the medium access controller 32 in an independent network discovery mode of operation.

The medium access controller 32 independently initiates transitions from a scanning state to a power conserving state and from the power conserving state to the scanning state (FIG. 4, block 70). In some embodiments, the medium access controller 32 independently transitions from the scanning state to the power conserving state after failing to discover any of the target access points in a scan of frames received by the wireless transceiver 30. In some embodiments, the medium access controller 32 independently transitions from the power conserving state to the scanning state in response to a determination that a specified sleep interval has expired. The sleep interval may be specified in the auto-scan request received from the host processing module 26 or it may be specified in the configuration data that is stored in the memory 62 (see FIG. 3).

In the scanning state, the medium access controller 32 outputs at least one transceiver control signal specifying at least one wireless channel and scans received frames for identifiers of one or more respective target access points (FIG. 4, block 72). In some embodiments, the medium access controller 32 outputs a report signal comprising a respective indication of each of the target access points discovered in a scan of frames received by the wireless transceiver 30. If the host processing unit 26 is in a low-power mode of operation when it receives the report signal, the receipt of the report signal will cause the host processing unit 26 to transition from the low-power mode of operation to a wake mode of operation. Typically, the medium access controller 32 will transmit the report signal in the form of an initial interrupt signal that wakes the host processing unit 26, if necessary, followed by one or more frames that communicate the reason for the interrupt.

In the power conserving state, the medium access controller 32 outputs at least one medium access control signal dictating a low-power mode of operation (FIG. 4, block 74). In some embodiments, the medium access control signal places at least one of the wireless transceiver 30 and the medium access controller 32 in a low-power mode of operation. In this process, the medium access controller 32 typically deactivates as many components of the wireless module 30 as possible, including but not limited to the I/O, up- and down-conversion, and baseband stages 50, 52, 54 of the wireless transceiver 30, and one or more components of the MAC processing unit 60. The medium access control signal disables the power and/or clock signals to these components or places these components in an idle mode of operation. When a wake-up event is detected (e.g., receipt of a sleep interval expiration signal from the timer 64 or an interrupt signal from the host processing unit 26), one or more components of the MAC processing unit 60 wake-up, analyze the wake-up event, and reactivate a specified set of components that are needed to respond to the wake-up event.

In some embodiments, the medium access controller 32 responds to the receipt of an auto-scan request signal from the host processing unit 26 by entering an independent network discovery state during which the medium access controller 32 independently transitions between the scanning state and the power conserving state without prompting by any additional signals from the host processing unit 26. In these embodiments, after receipt of the auto-scan request signal, the MAC enters the scanning state and scans the received frames for identifiers of one or more target access points specified in the host command. After discovering at least one of the specified target access points, the medium access controller 32 transitions out of the independent network discovery state without transitioning to the low-power state. The medium access controller 32 also transitions out of the independent network discovery state in response to receipt of an interrupt signal from the host processing unit 26.

C. A Second Embodiment of Independent Medium Access Control for Discovering Wireless Networks

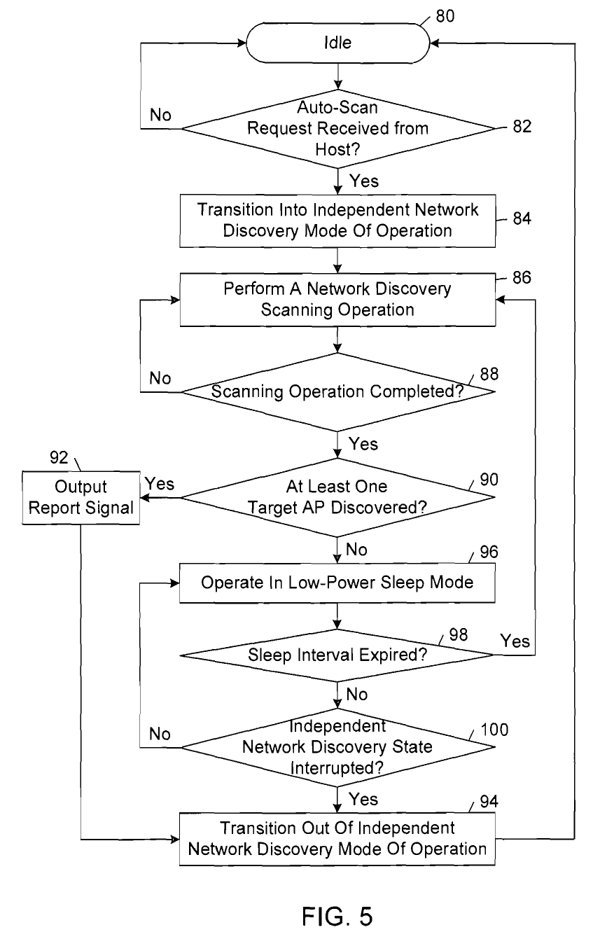

FIG. 5 shows an exemplary embodiment of an independent network discovery method that is implemented by embodiments of the medium access controller 32. In accordance with this method, the medium access controller 32 initially is in an idle state (FIG. 5, block 80). Typically, during the idle state, the medium access controller 32 listens for data but does not pass any data to the host processing unit 26 The medium access controller 32 remains in the idle state (FIG. 5, block 80), until an auto-scan request has been received from the host (FIG. 5, block 82). If an auto-scan request has been received (FIG. 5, block 82), the medium access controller 32 transitions into an independent network discovery mode of operation (FIG. 5, block 84).

In some embodiments, the medium access controller 32 is configured to perform MAC layer functions in accordance with a wireless communications protocol that conforms to the IEEE 802.11 standard but additionally includes provisions for auto-scan enabled MAC layer functionality. In some of these embodiments, the MLME-SCAN.request primitive defined in the IEEE 802.11 protocol is modified to include an AutoScan parameter with a value that indicates whether the medium access controller should perform a standard scan as defined in the 802.11 protocol or perform an independent network discovery scan in accordance with the embodiments described herein. In one exemplary embodiment, the modified MLME-SCAN.request primitive includes the following parameters: BSSType, BSSID, SSID, ScanType, ProbeDelay, ChannelList, MinChannelTime, MaxChannelTime, and AutoScan. These parameters are defined below in TABLE 1.

TABLE 1

| Name | Type | Valid range | Description |
|---|---|---|---|
| BSSType | Enumeration | INFRASTRUCTURE, | Determines whether infrastructure |
| | | INDEPENDENT, ANY_BSS | BSS, |
| | | | Independent BSS, or both, are |
| | | | included in |
| | | | the scan |
| BSSID | MACAddress | Any valid individual or | Identifies a specific or broadcast |
| | | broadcast MAC address | BSSID |
| SSID | Octet | string 0–32 octets | Specifies the desired SSID or the |
| | | | broadcast SSID |
| ScanType | Enumeration | ACTIVE, PASSIVE | Indicates either active or passive |
| | | | scanning |
| ProbeDelay | Integer | N/A | Delay (in μs) to be used prior to |
| | | | transmitting a Probe frame during |
| | | | active scanning |
| ChannelList | Ordered set of | Each channel will be selected | Specifies a list of channels that are |
| | integers | from the valid channel range | examined when scanning for a BSS |
| | | for the appropriate PHY and | MinChannelTime Integer |
| | | carrier set, | |
| MinChannelTime | Integer | ≧ProbeDelay | The minimum time (in TU) to spend on |
| | | | each channel when scanning |
| MaxChannelTime | Integer | ≧MinChannelTime | The maximum time (in TU) to spend |
| | | | on each channel when scanning |
| AutoScan | Binary | YES, NO | Indicates whether auto-scan is |
| | | | requested or not |

In these embodiments, the medium access controller 32 determines that an auto-scan request has been received from the host processing unit 26 if the AutoScan parameter value in the MLME-SCAN.request primitive is “YES”. If the AutoScan parameter value in the MLME-SCAN.request primitive is “NO”, the medium access controller 32 determines that an auto-scan request has not been received.

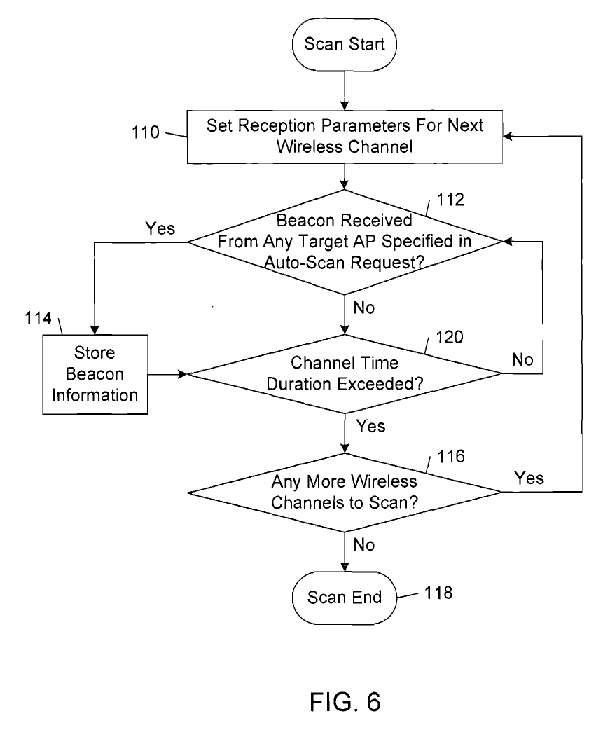

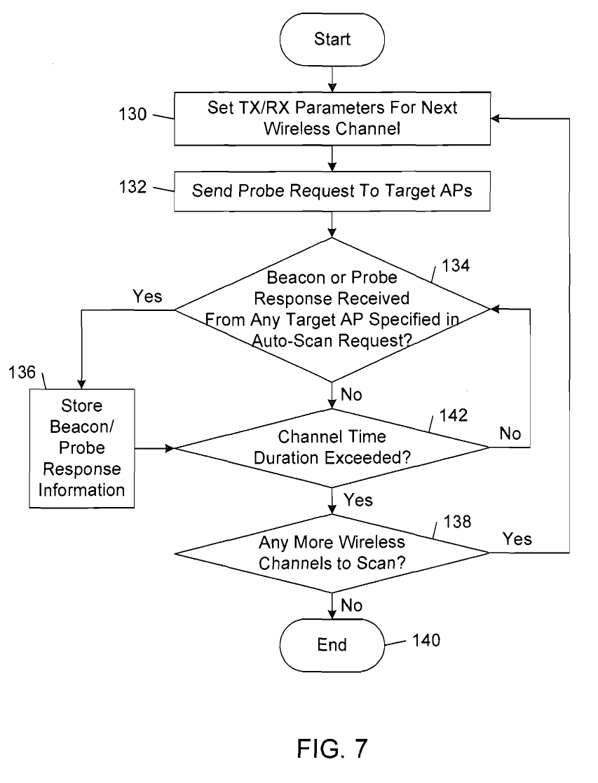

In the independent network discovery mode of operation, the medium access controller 32 performs a network discovery scanning operation (FIG. 5, block 86). In some embodiments, the auto-scan request contains parameter values that control the way in which the medium access controller 32 performs the scanning operation. For example, in embodiments in which the auto-scan request is embedded in the modified MLME-SCAN.request primitive defined in TABLE 1, the medium access controller performs either a passive scan or an active scan depending on the value of the ScanType parameter. In these embodiments, the medium access controller 32 implements the scanning operation in accordance with the IEEE 802.11 protocol. The IEEE 802.11 passive scanning operation is described below in connection with FIG. 6. The IEEE 802.11 active scanning operation is described below in connection with FIG. 7. In other embodiments, the medium access controller 32 performs the scanning operation in accordance with a default set of configuration parameters that is stored in memory 64.

In the network discovery scanning process (FIG. 5, block 84), the medium access controller 32 directs the wireless transceiver to scan one or more wireless channels, which typically are specified in the auto-scan request. In the modified MLME-SCAN.request defined in TABLE 1, these channels are specified by the ChannelList parameter values. The medium access controller 32 scans the frames that are received by the wireless transceiver 30 for identifiers of one or more target access points, which typically also are specified in auto-scan request. In the modified MLME-SCAN.request defined in TABLE 1, these identifiers are specified by the SSID parameter values.

After the network discovery scanning operation has been completed (FIG. 5, block 88), the medium access controller 32 determines whether at least one target access point (AP) was discovered in the scan (FIG. 5, block 90). If at least one target access point has been discovered (FIG. 5, block 90), the medium access controller 32 outputs a report signal to the host processing unit 26 (FIG. 5, block 92). If the host processing unit 26 is in a low-power mode of operation when it receives the report signal, the receipt of the report signal will cause the host processing unit 26 to transition from the low-power mode of operation to a wake mode of operation. Typically, the medium access controller 32 will transmit the report signal in the form of an initial interrupt signal that wakes the host processing unit 26, if necessary, followed by one or more frames that communicate the reason for the interrupt. After the report signal has been output, the medium access controller 32 transitions out of the independent discovery mode of operation (FIG. 5, block 94) and returns to the idle state (FIG. 5, block 80).

In some embodiments, the report signal is in the form of the MLME-SCAN.confirm primitive, which is defined by the IEEE 802.11 protocol and includes the following parameters: BSSDescriptionSet; and ResultCode. These parameters are defined below in TABLE 2 and TABLE 3.

TABLE 2

| Name | Type | Valid range | Description |
|---|---|---|---|
| BSSDescriptionSet | Set of | N/A | The SSDescriptionSet is returned to |
| | BSSDescriptions | | indicate the results of the scan request. It is |
| | | | a set containing zero or more instances of |
| | | | a BSSDescription. |
| ResultCode | Enumeration | INVALID_PARAMETERS | indicates the results of the MLME- |
| | | | SCAN.confirm |

Each BSSDescription consists of the following elements:

TABLE 3

| Name | Type | Valid range | Description |
|---|---|---|---|
| BSSID | MACAddress | N/A | The BSSID of the found BSS |
| SSID | Octet string | 1–32 octets | The SSID of the found BSS |
| BSSType | Enumeration | INFRASTRUCTURE, | The type of the found BSS |
| | | INDEPENDENT | |
| Beacon Period | Integer | N/A | The Beacon period of the found BSS (in TU) |
| DTIM Period | Integer | As defined in frame | The DTIM period of the BSS (in |
| | | format | beacon periods) |
| Timestamp | Integer | N/A | The timestamp of the received frame |
| | | | (probe response/beacon) from the found BSS |
| Local Time | Integer | N/A | The value of the STA's TSF timer at the start of |
| | | | reception of the first octet of the timestamp |
| | | | field of the received frame (probe response or |
| | | | beacon) from the found BSS |
| PHY parameter set | As defined in | As defined in frame | The parameter set relevant to the PHY |
| | frame format | format | |
| CF parameter set | As defined in | As defined in frame | The parameter set for the CF periods, if found |
| | frame format | format | BSS supports CF mode |
| IBSS parameter set | As defined in | As defined in frame | The parameter set for the IBSS, if found BSS |
| | frame format | format | is an IBSS |
| CapabilityInformation | As defined in | As defined in frame | The advertised capabilities of the BSS |
| | frame format | format | |
| BSSBasicRateSet | Set of integers | 2–127 inclusive (for | The set of data rates (in units of |
| | | each integer in the set) | 500 kb/s) that must be supported by all |
| | | | STAs that desire to join this BSS. The |
| | | | STAs must be able to receive at each of the |
| | | | data rates listed in the set. |

If at least one target access point was not discovered in the scan (FIG. 5, block 90), the medium access controller 32 operates in a low-power sleep mode (FIG. 5, block 96). In this process, the medium access controller 32 sets the timer 64 (FIG. 3) to begin measuring the current sleep interval. The medium access controller 32 also places at least one of the wireless transceiver 30 and the medium access controller 32 in a low-power state of operation. In this process, the medium access controller 32 typically deactivates as many components of the wireless module 30 as possible, including but not limited to the I/O, up- and down-conversion, and baseband stages 50, 52, 54 of the wireless transceiver 30, and one or more components of the MAC processing unit 60. The medium access controller 32 typically outputs at least one control signal that disables the power and/or clock signals to these components or places these components in an idle mode of operation. The medium access controller 32 remains in the low-power sleep mode until it receives a signal from the timer 64 indicating that the sleep interval has expired (FIG. 5, block 98). After determining that the sleep interval has expired (FIG. 5, block 98), the medium access controller 32 transitions back into the scanning state (FIG. 5, block 86). In some embodiments, the medium access controller 32 transitions back into the scanning state in response to receipt of a sleep interval expiration signal from the timer 64. In this process, one or more components of the MAC processing unit 60 wake-up, analyze the sleep interval expiration signal, and reactivate a specified set of components that are needed to perform the scanning operation.

If the sleep interval has not expired (FIG. 5, block 98), the medium access controller 32 determines whether the independent network discovery state has been interrupted (FIG. 5, block 100). The independent network discovery state may be interrupted, for example, by the receipt of an interrupt signal from the host processing unit 26. If the independent network discovery state has not been interrupted (FIG. 5, block 100), the medium access controller 32 remains in the sleep state (FIG. 5, block 96). If the independent network discovery state has been interrupted (FIG. 5, block 100), the medium access controller 32 transitions out of the independent discovery mode of operation (FIG. 5, block 94) and returns to the idle state (FIG. 5, block 80). In some embodiments, the medium access controller 32 transitions out of the independent discovery mode of operation in response to receipt of an interrupt signal from the host processing unit 26. In this process, one or more components of the MAC processing unit 60 wake-up, analyze the interrupt signal, and reactivate a specified set of components that are needed to perform the functions needed in the idle state.

D. Scanning in Embodiments of Independent Medium Access Control for Discovering Wireless Networks

FIG. 6 shows an embodiment of a method in accordance with which the medium access controller 32 passively scans for target access points while in the independent network discovery scanning mode of operation (see, e.g., FIG. 5, block 86). In the passive scanning mode, the wireless module 30 passively receives on one or more specified wireless channels and returns a beacon report containing information about each access point from which a beacon was received.

In accordance with this method, the medium access controller 32 sets the receipt parameters of the wireless transceiver 30 for the next wireless channel on which to receive frames (FIG. 6, block 110). In the modified MLME-SCAN.request is defined in TABLE 1, these channels are specified by the ChannelList parameter values. The wireless transceiver 30 listens for beacon signals of access points in the vicinity of the wireless station 14.

The medium access controller 32 processes the signals received by the wireless transceiver 30 into frames and scans the frames for identifiers of one or more target access points that are specified in auto-scan request (FIG. 6, block 112). In the modified MLME-SCAN.request defined in TABLE 1, these identifiers are specified by the SSID parameter values.

If the frames contain the identifier of at least one target access point (FIG. 6, block 112), the medium access controller 32 stores the beacon information in memory 62 (FIG. 6, block 114). If the extracted frames do not contain the identifier of at least one target access point (FIG. 6, block 112), the medium access controller determines whether or not the channel time duration has been exceeded (FIG. 6, block 120). In the modified MLME-SCAN.request defined in TABLE 1, the channel time duration is specified by the MaxChannelTime parameter value. The medium access controller 32 continues to scan the current channel until the channel time duration has been exceeded (FIG. 6, block 120).

If there are wireless channels that have not yet been scanned (FIG. 6, block 116), the medium access controller 32 sets the reception parameters of the wireless transceiver 30 for the next wireless channel (FIG. 6, block 110) and repeats the process. Otherwise the scanning process terminates (FIG. 6, block 118) and the network discovery process of FIG. 5 resumes at block 88.

FIG. 7 shows an embodiment of a method in accordance with which the medium access controller 32 actively scans for target access points while in the independent network discovery scanning mode of operation (see, e.g., FIG. 5, block 86). In the active scanning mode, the wireless module 30 transmits a probe request and returns a beacon report containing information about each access point from which a beacon or a probe response was received.

In accordance with this method, the medium access controller 32 sets the transmit/receive (TX/RX) parameters of the wireless transceiver 30 for the next wireless channel on which to transmit and receive frames (FIG. 7, block 130). In the modified MLME-SCAN.request defined in TABLE 1, these channels are specified by the ChannelList parameter values.

The medium access controller 32 sends probe requests to one or more target access points specified in the auto-scan request (FIG. 7, block 132). Each probe request typically includes the identifiers of the one or more target access points, and information about the wireless communication rates supported by the wireless station 10. In the modified MLME-SCAN.request defined in TABLE 1, the access point identifiers are specified by the SSID parameter values. The wireless transceiver 30 listens for beacon signals of access points in the vicinity of the wireless station 14.

The medium access controller 32 processes the signals received by the wireless transceiver 30 into frames. These signals may be beacon signals or probe response signals. The medium access controller 32 scans the frames for the identifiers of the one or more target access points that are specified in auto-scan request (FIG. 7, block 134).

If the frames contain the identifier of at least one target access point (FIG. 7, block 134), the medium access controller 32 stores the beacon or probe response information in memory 62 (FIG. 7, block 136). If the extracted frames do not contain the identifier of at least one target access point (FIG. 7, block 136), the medium access controller 32 determines whether or not the channel time duration has been exceeded (FIG. 7, block 140). In the modified MLME-SCAN.request defined in TABLE 1, the channel time duration is specified by the MaxChannelTime parameter value. The medium access controller 32 continues to scan the current channel until the channel time duration has been exceeded (FIG. 7, block 134).

If there are wireless channels that have not yet been scanned (FIG. 7, block 138), the medium access controller 32 sets the transmit/receive (TX/RX) parameters of the wireless transceiver 30 for the next wireless channel (FIG. 7, block 130) and repeats the process. Otherwise the scanning process terminates (FIG. 7, block 140) and the network discovery process of FIG. 5 resumes at block 88.

### V. Conclusion

The embodiments that are described in detail herein support power reduction strategies during wireless network discovery. In particular, these embodiments include an “auto-scan” enabled medium access controller that is operable to independently initiate transitions from a network discovery scanning state to a power conserving state and from the power conserving state to the scanning state. This feature allows the power consumed in these embodiments to be significantly reduced in relation to wireless stations in which the host processing unit is involved in each scan operation that is performed by the medium access controller.

Other embodiments are within the scope of the claims.

What is claimed is:

1. An apparatus, comprising:
a wireless transceiver operable to transmit and receive wireless signals; and
a medium access controller operable to independently initiate transitions from a scanning state to a power conserving state and from the power conserving state to the scanning state, wherein in the scanning state the medium access controller directs the wireless transceiver to receive frames on at least one wireless channel and the medium access controller scans the received frames for identifiers of one or more respective target access points, and in the power conserving state the medium access controller places at least one of the wireless transceiver and the medium access controller in a low-power mode of operation.

2. The apparatus of claim 1, wherein the medium access controller outputs a report signal comprising a respective indication of each of the target access points discovered in a scan of frames received by the wireless transceiver.

3. The apparatus of claim 1, wherein the medium access controller independently transitions from the scanning state to the power conserving state after failing to discover any of the target access points in a scan of frames received by the wireless transceiver.

4. The apparatus of claim 1, wherein the medium access controller independently transitions from the power conserving state to the scanning state in response to a determination that a specified sleep interval has expired.

5. The apparatus of claim 1, further comprising a host processing unit comprising at least one host processor.

6. The apparatus of claim 5, wherein:
in response to receipt of a request signal from the host processing unit, the medium access controller enters an independent network discovery state during which the medium access controller independently transitions between the scanning state and the power conserving state without prompting by any additional signals from the host processing unit.

7. The apparatus of claim 6, wherein after receipt of the request signal the medium access controller enters the scanning state and scans the received frames for identifiers of one or more target access points specified in the host command.

8. The apparatus of claim 7, wherein:
after discovering at least one of the specified target access points, the medium access controller transitions out of the independent network discovery state without transitioning to the low-power state.

9. The apparatus of claim 7, wherein the medium access controller transitions out of the independent network discovery state in response to receipt of an interrupt signal from the host processing unit.

10. The apparatus of claim 6, wherein:
after transmitting the request signal to the medium access controller, the host processing unit enters a low-power state of operation during which data communications from the host processing unit to the medium access controller are suspended.

11. The apparatus of claim 1, wherein the medium access controller is operable to perform medium access control layer functions in accordance with at least one wireless communications protocol selected from IEEE 802.11, IEEE 802.15.1 (Bluetooth), and IEEE 802.15.4 (Zigbee).

12. A machine readable medium storing machine-readable instructions causing a medium access controller to perform operations comprising:
in a scanning state, outputting at least one transceiver control signal specifying at least one wireless channel from which to receive frames and scanning received frames for identifiers of one or more respective target access points;
in a power conserving state, outputting at least one medium access control signal dictating a low-power mode of operation; and
independently initiating transitions from the scanning state to the power conserving state and from the power conserving state to the scanning state.

13. The machine readable medium of claim 12, wherein the machine-readable instructions cause the medium access controller to output a report signal comprising a respective indication of each of the target access points discovered in a scan of the received frames.

14. The machine readable medium of claim 12, wherein the machine-readable instructions cause the medium access controller to transition independently from the scanning state to the power conserving state after failing to discover any of the target access points in a scan of the received frames.

15. The machine readable medium of claim 12, wherein the machine-readable instructions cause the medium access controller to transition independently from the power conserving state to the scanning state in response to a determination that a specified sleep interval has expired.

16. The machine readable medium of claim 12, wherein the machine-readable instructions cause the medium access controller to independently initiate transitions from the scanning state to the power conserving state and from the power conserving state to the scanning state without prompting by request signals received from a host processing unit.

17. A medium access control method, comprising:
in a scanning state, outputting at least one transceiver control signal specifying at least one wireless channel and scanning received frames for identifiers of one or more respective target access points;
in a power conserving state, outputting at least one medium access control signal dictating a low-power mode of operation; and
independently initiating transitions from the scanning state to the power conserving state and from the power conserving state to the scanning state.

18. The method of claim 17, further comprising outputting a report signal comprising a respective indication of each of the target access points discovered in a scan of the received frames.

19. The method of claim 17, wherein the independently initiating transitions comprises independently initiating a transition from the scanning state to the power conserving state after failing to discover any of the target access points in a scan of the received frames.

20. The method of claim 17, wherein the independently initiating transitions comprises independently initiating a transition from the power conserving state to the scanning state in response to a determination that a specified sleep interval has expired.

21. The method of claim 17, wherein the independently initiating transitions is performed without prompting by requests from a lost processing unit.

22. The method of claim 17, further comprising performing medium access control layer functions in accordance with at least one wireless communications protocol selected from IEEE 802.11, IEEE 802.15.1 (Bluetooth), and IEEE 802.15.4 (Zigbee).
